(19) United States
(12) Patent Application Publication
(10) Pub. No.: US 2018/0184188 A1
(43) Pub. Date: Jun. 28, 2018

(54) Portable Bluetooth Headset With Step-Counting Function

(71) Applicant: Shenzhen Link Dream Electronic Technology Co., Ltd., Shenzhen (CN)

(72) Inventor: Hong Liu, Hunan Province (CN)

(21) Appl. No.: 15/403,369

(22) Filed: Jan. 11, 2017

(30) Foreign Application Priority Data
Dec. 23, 2016 (CN) 201611209014X

(51) Int. Cl. H04R 1/10; G01C 22/00

(52) U.S. Cl. CPC H04R 1/1008; H04R 1/1091; H04R 1/1025; H04R 2420/07; H04R 1/105; H04R 1/1041; G01C 22/006; H04R 1/1083

(57) ABSTRACT

Provided is a portable Bluetooth headset with a step-counting function, comprising a pair of main bodies each with a speaker, as well as a headband, the main bodies being slidably connected to both ends of the headband, a wireless charging module is disposed at the center of the headband, a Bluetooth control component, a pedometer and a battery are disposed in the main body, the wireless charging module is electrically connected to the battery, and the battery operates to charge all loads of the headset. The invention as a powerful Bluetooth headset features a wireless charging function so that no charging cable is required whenever in operation or in charging, as well as a step-counting function enabling a user wearing the headset to count steps during running

### TECHNICAL FIELD

The invention relates to the field of earphones, and more particularly to a portable Bluetooth headset with a step-counting function.

### BACKGROUND

Earphones are a pair of signal conversion units that receive electric signals, and transform the signals into audible sound waves by using a speaker positioned around a user's ear. Normally the earphone is independent from a media player, and these two are connected to each other via an earphone jack. The earphone makes it possible for a user to listen to the media player alone without interfering people around him/her. In addition, the earphone can isolate environment noise, which is especially helpful for a user in a noisy environment such as a record room, a DJ, a journey, an exercise, and so on. The earphones are initially designed for use in telephones and radios, but with popularity of portable electronic devices, the earphones are widely used in mobile phones, Walkmans, radio sets, portable video games, digital audio players and so on. It can be learned from development of the audio industry that, wireless earphones are still very new, the industry itself does not experience a long development time and is now at a rising stage, requirements and expectation from users are increasingly growing, which proposes a new challenge for the industry. In recent years, the earphone industry develops rapidly, earphones have more and more functions including the Bluetooth. However, functions of existing Bluetooth headsets are inadequate; moreover, charging of the existing Bluetooth headsets is not convenient, and needs an extra charger, which make the headsets impractical.

### SUMMARY

In view of the above-mentioned problems, it is an objective of the invention to provide a powerful and portable Bluetooth headset with a step-counting function that features a wireless charging function so that no charging cable is required whenever in operation or in charging, as well as a step-counting function enabling a user wearing the headset to count steps during running

In accordance with an exemplary embodiment of the invention, provided is a portable Bluetooth headset with a step-counting function, comprising a pair of main bodies each with a speaker, as well as a headband, the main bodies being slidably connected to both ends of the headband, a wireless charging module is disposed at the center of the headband, a Bluetooth control component, a pedometer and a battery are disposed in the main body, the wireless charging module is electrically connected to the battery, and the battery operates to charge all loads of the headset.

Advantageously, the two main bodies are respectively a first main body and a second main body, the Bluetooth control component and the pedometer are disposed in the first main body, and an auxiliary circuit board and the battery are disposed in the second main body.

Advantageously, the Bluetooth control component comprises a Bluetooth module, a LED indicator light, a function key, a MIC, and a first antenna, the LED indicator light, the function key, the MIC and the first antenna are respectively connected to the Bluetooth module, the auxiliary circuit board comprises a noise reduction circuit, a noise elimination circuit, and a MIC signal collection circuit, the noise elimination circuit, the MIC signal collection circuit, and the speakers are respectively connected to the noise reduction circuit, and the noise reduction circuit is connected to the Bluetooth module via a differential signal line.

Advantageously, the pedometer comprises a microcontroller, a triaxial accelerometer, a timer, a WIFI, a Bluetooth communication interface, and a second antenna, and the triaxial accelerometer, the timer, the WIFI, the Bluetooth communication interface and the second antenna are connected to the microcontroller.

Advantageously, a pair of sliders are connected to both ends of the headband, a press button is disposed on the headband, and the main body is rotably connected to one end of the slider.

Advantageously, the main body comprises an earphone part and a connector, the connector is rotably connected to the earphone part, a rotation axis is disposed on the connecter, and is rotatable with respect to the connector, and the rotation axis is rotably connected to the slider.

Advantages of the invention are that, the invention features a wireless charging function, charging of the headset can be done by just putting the headband on the wireless charger, and the headset can operate during charging; in addition, the invention features a step-counting function, which makes it possible for users to make full use of the headset's advantages in terms of wireless functions during running or outdoor activities, counting steps and playing audio wirelessly enable a user to like running and outdoor activities, and are of great health value.

### BRIEF DESCRIPTION OF THE DRAWINGS

FIG. 1 is a schematic view of a portable Bluetooth headset with a step-counting function of an exemplary embodiment of the invention;

FIG. 2 is an exploded view of a portable Bluetooth headset with a step-counting function of an exemplary embodiment of the invention;

FIG. 3 is a schematic block diagram of a portable Bluetooth headset with a step-counting function of an exemplary embodiment of the invention;

FIG. 4 is a schematic block diagram of a pedometer of the invention; and

FIG. 5 is a schematic view of a portable Bluetooth headset of the invention during rotation.

### DETAILED DESCRIPTION OF THE INVENTION

Detailed description of the invention will be given below in conjunction with accompanying drawings and specific embodiments. It should be noted that the embodiments are only meant to explain the invention, and not to limit the scope of the invention.

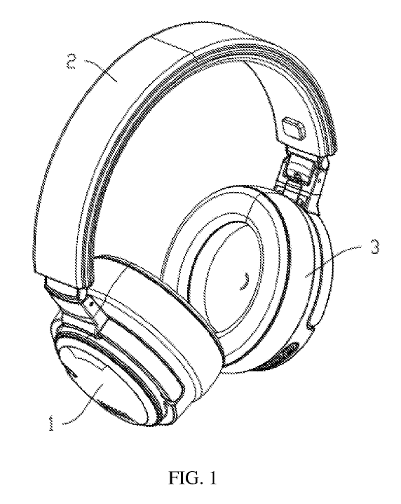

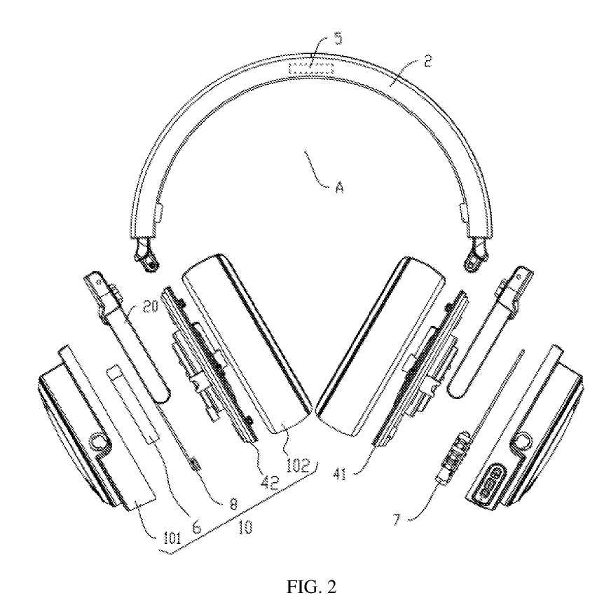

As shown in FIGS. 1 and 2, a portable Bluetooth headset with a step-counting function of the invention comprises a pair of main bodies with two speakers 41 and 42, as well as a headband 2. The two main bodies are a left main body 1 and a right main body 3. A left speaker 42 is disposed in the left main body 1, and a right speaker 41 is disposed in the right main body 3. The left main body 1 and the right main body 3 are respectively slidably connected to both ends of the headband 2. The headband 2 may be made of plastic or metals, and has a certain radian. A contact can be disposed on the headband 2 for relaxing a user's head. In this embodiment, the headband is not shown in the figures. A wireless charging module 5 is disposed at the center of the headband 2. The wireless charging module 5 comprises a wireless charging coil and a wireless charging circuit, and the wireless charging circuit can be conveniently disposed in the headband as a small PCB board. A Bluetooth control component 7, a pedometer and a battery 6 are disposed in the main body, and it should be noted that they can be disposed in one main body alone, or separately disposed in two main bodies. The wireless charging module 5 is electrically connected to the battery 6. The battery 6 operates to supply power to all loads of the headset. Specifically, the wireless charging coil is connected to the PCB board, the PCB board is connected to the battery 6, and the battery 6 is a lithium battery.

As a preferred embodiment of the invention, as shown in FIG. 2, the two main bodies are a first main body and the a main body, the first main body is a right main body 3, and the second main body is a left main body 1. A Bluetooth control component 7 and a pedometer are disposed in the first main body. An auxiliary circuit board 8 and a battery 6 are disposed in the second main body. In this embodiment, by appropriately arranging all circuit boards and the battery, it is possible to improve space utilization, and to make structure of the headset more rationalized.

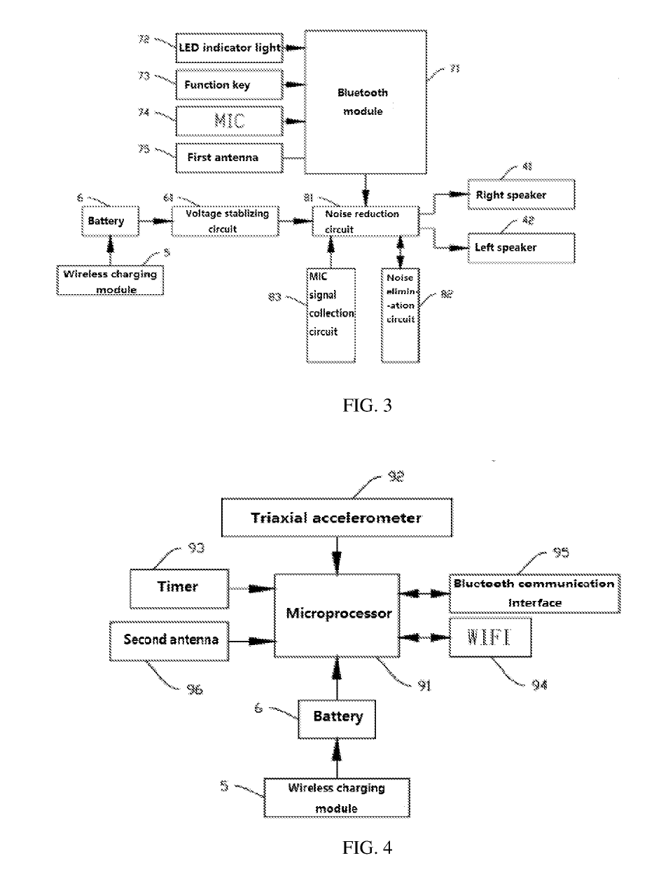

Preferably, as shown in FIG. 3, the Bluetooth control component 7 comprises a Bluetooth module 71, a LED indicator light 72, a function key 73, a MIC74, and a first antenna 75. The LED indicator light 72, the function key 73, the MIC74 and the first antenna 75 are respectively connected to the Bluetooth module 71, and the Bluetooth module 71 may employ a CSR8635 chip. The auxiliary circuit board 8 comprises a noise reduction circuit 81, a noise elimination circuit 82, and a MIC signal collection circuit 83. The noise elimination circuit 82, the MIC signal collection circuit 83, and the two speakers 4 are respectively connected to the noise reduction circuit 81. The noise reduction circuit 81 is connected to the Bluetooth module 71 via a differential signal line. The battery 6 is connected to the noise reduction circuit 81 via a voltage stabilizing circuit 61 thereby supplying power thereto. The headset of this preferred embodiment features a noise reduction and elimination function, and can make music more pleasant.

Preferably, as shown in FIG. 4, the pedometer comprises a microcontroller 91, a triaxial accelerometer 92, a timer 93, a WIFI 94, a Bluetooth communication interface 95, and a second antenna 96. The triaxial accelerometer 92, the timer 93, the WIFI 94, the Bluetooth communication interface 95 and the second antenna 96 are connected to the microcontroller 91. The triaxial accelerometer 92 may employ a three-axis accelerometer, a six-axis accelerometer, or a nine-axis accelerometer. As a user wearing the headset runs or takes exercises, the triaxial accelerometer generates a step-counting signal, then the step-counting signal is transmitted to the microprocessor for signal processing, and then step-counting information is transferred to a mobile phone by the WIFI or the Bluetooth communication interface, telling the user the number of steps that are recorded in step-counting time, so that the user can obtain the amount of exercise.

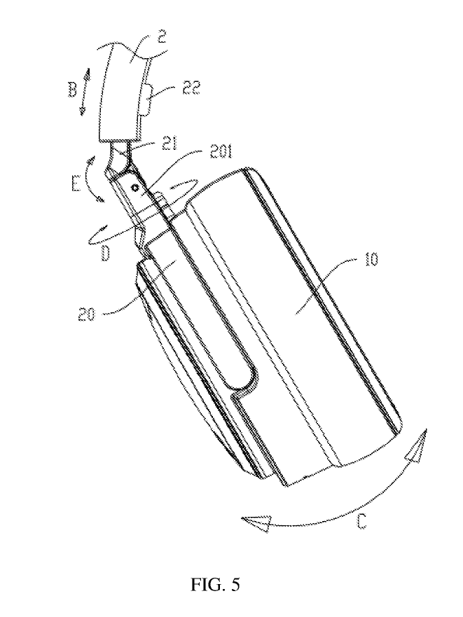

As shown in FIG. 5, a pair of sliders 21 are connected to both ends of the headband 2, a press button 22 is disposed on the headband 2, and the main bodies 1 and 3 are rotably connected to one end of the slider 21. The main bodies 1 and 3 are capable of stretching with respect to the headband 2 via the slider 21, and a direction of stretching is indicated by a label ‘B’ in FIG. 5. Specifically, each of the main bodies 1 and 3 comprises an earphone part 10 and a connector 20, the earphone part 10 (no matter the earphone part of the left main body 1, or that of the right main body 3, as described hereinbefore, the left main body 1 is an earphone part 10 with the auxiliary circuit board 8 and the battery 6, and the right main body 3 is an earphone part 10 with the Bluetooth control component 7 and the pedometer) has a shell 101. An ear cap 102 is disposed on the shell 101 of the earphone part 10, and operates to cover an ear of a user. The connector 20 is rotably connected to the earphone part 10, as indicated by a label ‘C’ in FIG. 5. The earphone part 10 can be inclined at a certain angle with respect to the headband via the connector 20. A rotation axis 201 is disposed on the connecter 20, and is rotatable with respect thereto. Rotation of the rotation axis 201 with respect to the connector 20 is indicated by a label ‘D’ in FIG. 5. The earphone part 10 can laterally rotate with respect to the headband 2, and the rotation axis 201 is rotably connected to the slider 21, as indicated by a label ‘E’ in FIG. 5. The earphone part 10, the connector 20 and the rotation axis 201 can, as a whole, be integrally folded and received in space A (as shown in FIG. 2) of the arc-shaped headband 2. Therefore, the headset of this preferred embodiment features large application range, is suitable for different populations, and can meet requirements for comfort from different perspective.

While preferred embodiments of the invention have been described above, the invention is not limited to disclosure in the embodiments and the accompanying drawings. Any changes or modifications without departing from the spirit of the invention fall within the scope of the invention.

What is claimed is:

1. A portable Bluetooth headset with a step-counting function, comprising a pair of main bodies each with a speaker, as well as a headband, said main bodies being slidably connected to both ends of said headband, wherein
a wireless charging module is disposed at the center of said headband;
a Bluetooth control component, a pedometer and a battery are disposed in said main body;
said wireless charging module is electrically connected to said battery; and
said battery operates to charge all loads of said headset.

2. The portable Bluetooth headset with a step-counting function of claim 1, wherein
said two main bodies are respectively a first main body and a second main body;
said Bluetooth control component and said pedometer are disposed in said first main body; and
an auxiliary circuit board and said battery are disposed in said second main body.

3. The portable Bluetooth headset with a step-counting function of claim 2, wherein
said Bluetooth control component comprises a Bluetooth module, a LED indicator light, a function key, a MIC, and a first antenna;
said LED indicator light, said function key, said MIC and said first antenna are respectively connected to said Bluetooth module;
said auxiliary circuit board comprises a noise reduction circuit, a noise elimination circuit, and a MIC signal collection circuit;
said noise elimination circuit, said MIC signal collection circuit, and said speakers are respectively connected to said noise reduction circuit; and
said noise reduction circuit is connected to said Bluetooth module via a differential signal line.

4. The portable Bluetooth headset with a step-counting function of claim 1, wherein
said pedometer comprises a microcontroller, a triaxial accelerometer, a timer, a WIFI, a Bluetooth communication interface, and a second antenna; and
said triaxial accelerometer, said timer, said WIFI, said Bluetooth communication interface and said second antenna are connected to said microcontroller.

5. The portable Bluetooth headset with a step-counting function of claim 1, wherein
a pair of sliders are connected to both ends of said headband;
a press button is disposed on said headband; and
said main body is rotably connected to one end of said slider.

6. The portable Bluetooth headset with a step-counting function of claim 5, wherein
said main body comprises an earphone part and a connector;
said connector is rotably connected to said earphone part;
a rotation axis is disposed on said connecter, and is rotatable with respect to said connector; and
said rotation axis is rotably connected to said slider.
